(19) United States
(12) Patent Application Publication
(10) Pub. No.: US 2020/0065036 A1
(43) Pub. Date: Feb. 27, 2020

(54) IMAGE FORMATION SYSTEM, IMAGE ASSESSMENT METHOD AND COMPUTER-READABLE RECORDING MEDIUM

(71) Applicant: Konica Minolta, Inc., Tokyo (JP)

(72) Inventor: Akio Ueda, Tokyo (JP)

(73) Assignee: Konica Minolta, Inc., Tokyo (JP)

(21) Appl. No.: 16/548,511

(22) Filed: Aug. 22, 2019

(30) Foreign Application Priority Data
Aug. 23, 2018 (JP) 2018-156626

(51) Int. Cl. G06F 3/12; G03G 15/00

(52) U.S. Cl. CPC G06F 3/1211; G06F 3/1259; G03G 2215/00616; G03G 2215/00042; G03G 15/5041

(57) ABSTRACT

An image formation system includes: a hardware processor that forms an image on a sheet based on a printing job, reads an output image formed on the sheet, assesses a quality of the output image based on the read output image, executes an invalid sheet process when an abnormal image is detected, interrupts the printing job when a time-over has occurred after executing the invalid sheet process; and restarts the printing job after inserting a divider sheet that indicates an occurrence of the time-over. The time-over occurs when quality assessment of the output image is completed outside of a predetermined time.

### CROSS-REFERENCE TO RELATED APPLICATIONS

The entire disclosure of Japanese Patent Application No. 2018-156626 filed on Aug. 23, 2018 is incorporated herein by reference in its entirety.

### BACKGROUND

### Technological Field

The present invention relates to an image formation system, an image assessment method and a computer-readable recording medium.

### Description of Related Art

In general, an electrophotographic image forming apparatus (such as a printer, a copier, a facsimile machine, and a multifunctional device) is configured to irradiate (expose) a uniformly charged photoconductor (e.g., a photoconductor drum) with light based on input image data to form an electrostatic latent image on the surface of the photoconductor. The electrostatic latent image is then visualized by supplying toner from a developing section to the photoconductor on which the electrostatic latent image is formed, whereby a toner image is formed. Further, the toner image is directly or indirectly transferred to a sheet through an intermediate transfer member (e.g., intermediate transfer belt), followed by heating and pressurization for fixing, whereby an image is formed on the sheet.

Conventionally, an image formation system in which an image optimization apparatus including a scanner and the like is provided downstream of the above-mentioned image forming apparatus in the sheet conveyance direction is known, and such an image formation system reads an image output from the image forming apparatus (i.e., an image printed on a sheet) with the scanner and the like, and provides a feedback information relating to the color and/or the positional displacement of the output image to the image forming apparatus for the purpose of improving image quality.

Further, in recent years, an image formation system is proposed in which a quality assessment apparatus configured to automatically assess the quality of output images from the image forming apparatus is provided in addition to the image forming apparatus and the image optimization apparatus (see, e.g., PTL 1 (Japanese Patent Application Laid-Open No. 2012-39424)).

The quality assessment apparatus assesses the quality of the output image on the basis of an image output from the image forming apparatus and a correct image for assessment prepared in advance. Then, when an abnormal image that falls short of a qualifying standard is detected, an invalid sheet process for removing the invalid sheet on which the abnormal image is formed is executed. An example of the invalid sheet process is a process of ejecting an invalid sheet to a purge tray differing from a tray to which normal sheets are ejected, for example.

However, an output image that requires a large processing load at the quality assessment apparatus (e.g., high resolution image) may cause time over (or time-over) in which the image analysis (quality assessment) is not completed before a preliminarily set executable timing of the invalid sheet process. No problem arises when the time-over sheet that has resulted in time over is a normal sheet; however, when the time-over sheet is an invalid sheet, the invalid sheet is mixed in normal sheets by being ejected to the normal sheet ejection tray, rather than the purge tray. In addition, once the time over occurs, the start timings of the image analysis for succeeding output images are delayed, and the time over tends to continuously occur. Consequently, the invalid sheet process may not be normally executed even when an abnormal image is detected.

As such, conventional image formation systems cannot guarantee the image quality of the output products when time over has occurred.

Note that it may be conceivable to adopt a method in which when time over has occurred, the image formation operation is stopped and the user is caused to check the output products; however, such a method is not preferable in view of reduction in productivity.

### SUMMARY

One or more embodiments of the present invention provide an image formation system, an image assessment method and a computer-readable recording medium that can guarantee the image quality of the output products even when time over has occurred.

An image formation system according to one or more embodiments of the present invention includes: an image forming section configured to form an image on a sheet on a basis of a printing job; an output image reading section configured to read an output image formed on the sheet; a quality assessment section configured to assess quality of the output image on a basis of a reading result of the output image reading section; and a hardware processor configured to perform (i.e., execute) an invalid sheet process when an abnormal image is detected by the quality assessment section, the hardware processor being configured to interrupt execution of the printing job when time over has occurred, and restart the printing job after inserting a divider sheet indicating occurrence of the time over. The time over occurs when quality assessment of the output image is not completed within a predetermined time (i.e., a predetermined duration of time).

An image assessment method according to one or more embodiments of the present invention includes: reading an output image formed on a sheet on a basis of a printing job; assessing quality of the output image on a basis of a reading result of the reading; performing an invalid sheet process when an abnormal image is detected by the assessing; and interrupting execution of the printing job when time over has occurred, and restarting the printing job after inserting a divider sheet indicating occurrence of the time over. The time over occurs when quality assessment of the output image is not completed within a predetermined time in the assessing.

A non-transitory computer-readable recording medium according to one or more embodiments of the present invention stores a program that causes a computer of an image formation system configured to form an image on a sheet on a basis of a printing job, to read an output image formed on the sheet, and to assess quality of the output image on a basis of a reading result, to execute a first processing of performing an invalid sheet process when an abnormal image is detected; and a second processing of interrupting execution of the printing job when time over has occurred, and restarting the printing job after inserting a divider sheet indicating occurrence of the time over. The time over occurs when quality assessment of the output image is not completed within a predetermined time.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a general configuration of an image formation system according to one or more embodiments;

FIG. 2 illustrates a principal part of a control system of the image formation system;

FIG. 3 is a flowchart of an exemplary invalid sheet process according to one or more embodiments;

FIG. 4 illustrates an exemplary recovery process in the case where an abnormal image is generated according to one or more embodiments;

FIG. 5 illustrates an exemplary insertion of a divider sheet in the case where time over has occurred according to one or more embodiments;

FIG. 6 is illustrates an exemplary execution of a printing job after insertion of a divider sheet according to one or more embodiments;

FIG. 7 illustrates an exemplary recovery process after insertion of a divider sheet according to one or more embodiments;

FIG. 8 illustrates an exemplary execution history of a printing job according to one or more embodiments;

FIG. 9 illustrates an exemplary invalid sheet process with insertion of a divider sheet according to one or more embodiments; and

FIG. 10 illustrates a problem associated with the invalid sheet process with insertion of a divider sheet according to one or more embodiments.

### DETAILED DESCRIPTION

Hereinafter, embodiments of the present invention will be described with reference to the drawings. However, the scope of the invention is not limited to the disclosed embodiments.

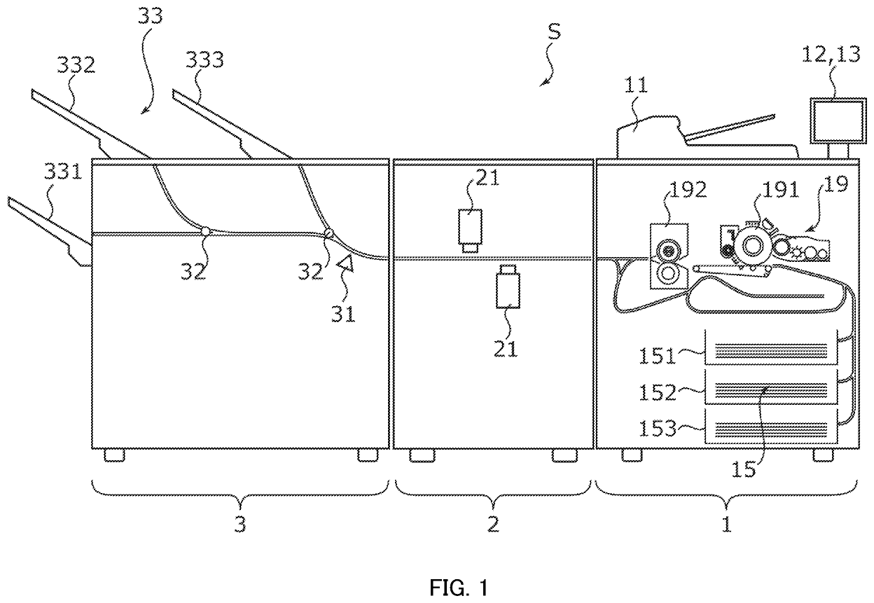

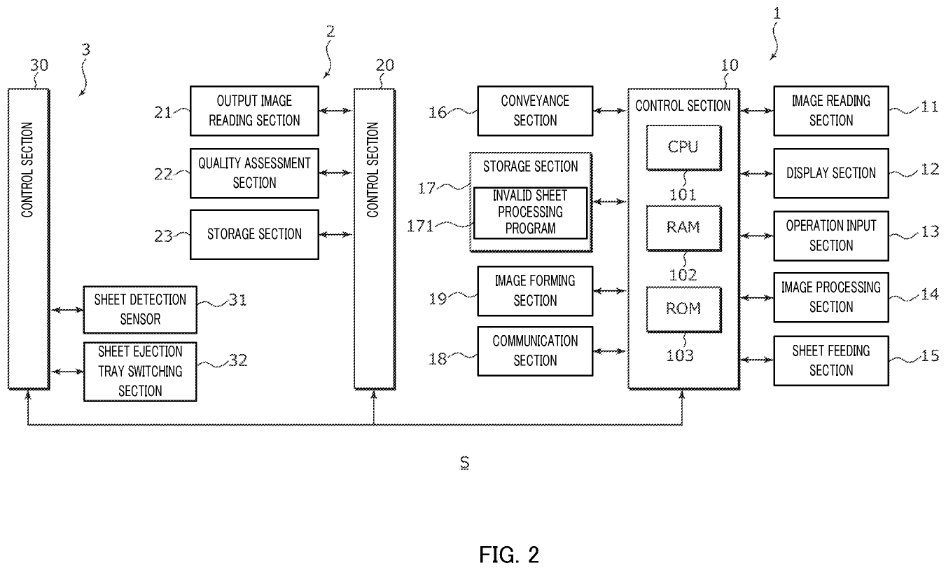

FIG. 1 illustrates a general configuration of image formation system S according to one or more embodiments. FIG. 2 illustrates a principal part of a control system of image formation system S. Note that, in FIG. 2, regarding image quality optimization apparatus 2 and post-processing apparatus 3, components relating to an invalid sheet process in image formation system S are mainly illustrated.

As illustrated in FIG. 1 and FIG. 2, image formation system S includes image forming apparatus 1, image quality optimization apparatus 2, and post-processing apparatus 3. Image forming apparatus 1, image quality optimization apparatus 2 and post-processing apparatus 3 are connected such that they can communicate with one another. Note that an external high-capacity sheet feeding apparatus may be connected upstream of image forming apparatus 1 such that sheets are fed from the external sheet feeding apparatus.

Image forming apparatus 1 is a color image forming apparatus using an electrophotographic process technique, for example. The hardware configuration of image forming apparatus 1 is publicly known, and is therefore briefly described. As illustrated in FIG. 1 and FIG. 2, image forming apparatus 1 includes document image reading section 11, display section 12, operation input section 13, image processing section 14, sheet feeding section 15, conveyance section 16, storage section 17, communication section 18, image forming section 19, control section 10 and the like.

For example, document image reading section 11 optically scans a document conveyed from an auto document feeder (ADF) onto a contact glass, forms an image of reflection light from the document on a light-receiving surface of a charge coupled device (CCD) sensor, and reads the document image. In this manner, input image data (document data) based on a reading result is generated.

For example, display section 12 is composed of a liquid crystal display, an organic EL display, a CRT display or the like. Display section 12 displays various setting screens, operating statuses of functions and the like under an instruction of CPU 101. Display section 12 displays a printing job screen for confirming the execution status of a printing job, for example. In one or more embodiments, in the printing job screen, presence/absence of time over can be confirmed, and an execution instruction of a recovery process can be provided when a time-over sheet is an invalid sheet.

Operation input section 13, which includes various operation keys such as numeric keys and a start key, receives various inputting operations from the user and outputs an operation signal to CPU 101. By operating operation input section 13, the user can perform setting relating to the image formation such as document setting, image quality setting, multiplying factor setting, application setting, output setting, and sheet setting.

Note that display section 12 and operation input section 13 may be integrally provided in the form of a flat-panel display with a touch panel, for example.

Image processing section 14 includes a circuit or the like that performs a digital image process on input image data in accordance with initial settings or user settings. For example, image processing section 14 performs tone correction based on tone correction data under control of CPU 101. In addition, image processing section 14 performs various correction processes, such as color correction, shading correction, and density correction, on input image data. Image forming section 19 is controlled on the basis of the image data that has been subjected to these processes.

Sheet feeding section 15 includes sheet feed trays 151 to 153 for storing various sheets. Flat sheets (standard sheets and special sheets) sorted on the basis of their basis weight, size and the like are stored in sheet feed trays 151 to 153 in advance on a predetermined type basis. Sheet feeding section 15 sends a sheet fed from sheet feed trays 151 to 153 to conveyance section 16. In one or more embodiments, a divider sheet that indicates occurrence of time over is stored in one of sheet feed trays 151 to 153.

Conveyance section 16 includes a main conveyance section, a switch-back conveyance section, a back-printing conveyance section, a sheet path switching section (which are not illustrated) and the like. For example, a part of conveyance section 16 may be incorporated in a single unit together with fixing section 192 so as to be detachably mounted to image forming apparatus 1. Conveyance section 16 conveys, to image forming section 19, a sheet fed from sheet feeding section 15, and discharges a sheet on which an image has been formed to the outside of the apparatus.

Image forming section 19 includes toner image forming section 191 for forming toner image with color toners of a Y-component, an M-component, a C-component, and a K-component on the basis of input image data, and fixing section 192 configured to fix a toner image transferred on a sheet.

In toner image forming section 191, when light based on input image data is applied to a uniformly charged photoconductor (e.g., a photoconductor drum) (optical exposure), an electrostatic latent image is formed on a photoconductor surface. Then, toner is supplied from the development section to the photoconductor on which the electrostatic latent image is formed, and thus the electrostatic latent image is visualized, and, a toner image is formed. After this toner image is transferred to a sheet, fixing section 192 applies heat and pressure thereto to form the image on the sheet.

Note that image forming section 19 may include an intermediate transfer section (e.g., an intermediate transfer belt) that indirectly transfers a toner image formed by toner image forming section 191 to a sheet.

Control section 10 includes a CPU (Central Processing Unit) 101 serving as a computing/control apparatus, a random access memory (RAM) 102 and a read only memory (ROM) 103 serving as main storage apparatuses and the like. ROM 103 stores a basic program and/or basic setting data. CPU 101 reads a program corresponding to a process from ROM 103 or storage section 17, develops the program in RAM 102, and executes the program, thus performing centralized control of the blocks of image forming apparatus 1. In addition, CPU 101 communicates with image optimization apparatus 2 and post-processing apparatus 3, and controls respective operations in conjunction with control section 20 of image optimization apparatus 2 and control section 30 of post-processing apparatus 3.

Note that, some processes or all processes executed by CPU 101 may be executed by electronic circuits such as a digital signal processor (DSP), an application specific integrated circuit (ASIC), and a programmable logic device (PLD) provided in accordance with the processes.

Storage section 17 is, for example, an auxiliary storage apparatus such as a nonvolatile semiconductor memory (so-called flash memory) and a hard disk drive. Storage section 17 may be a disk drive for reading and writing information by driving an optical disc such as a compact disc (CD) and a digital versatile disc (DVD), or an optical magnetic disc such as a magneto-optical disc (MO). In addition, for example, storage section 17 may be a memory card such as a USB memory and an SD card. Furthermore, a storage region on the cloud that is connected through communication section 18 may also be applied as storage section 17.

In one or more embodiments, storage section 17 stores an invalid sheet processing program for performing an invalid sheet process when an abnormal image is detected in quality assessment at image optimization apparatus 2. In addition, storage section 17 functions as a job history storage section, and stores data of a printing job that is executed. The data of the printing job may be erased after the printing job is executed, or may be retained even after the printing job as a preparation to execution of a recovery process after the printing job.

Communication section 18 has various interfaces such as a network interface card (NIC), a modulator-demodulator (MODEM), and a universal serial bus (USB), for example. Communication section 18 may be composed of a communication interface for near field wireless communication of near field communication (NFC), Bluetooth (registered trademark) or the like. Through communication section 18, CPU 101 sends and receives a variety of information to and from an external apparatus (e.g., personal computer) connected with a network such as a wired/wireless local area network (LAN). For example, CPU 101 receives printing job data sent from an external apparatus, and creates input image data on the basis of the printing job data. Printing job data is described in a predetermined page description language (PDL), and includes data of an image object such as a diagram and a photograph, and data of a text object such as letters and a mark, for example.

In one or more embodiments, CPU 101 is connected with control section 20 of image optimization apparatus 2 through communication section 18 so as to be able to mutually communicate with control section 20, and acquires information representing a result of the quality assessment from image optimization apparatus 2. In addition, CPU 101 is connected with control section 30 of post-processing apparatus 3 through communication section 18 so as to be able to mutually communicate with control section 30, and provides, to post-processing apparatus 3, an instruction about the discharge destination (sheet ejection tray) of sheets.

Image optimization apparatus 2 detects positional displacement and the color of images output from image forming apparatus 1, and sends a feedback about the detection result to image forming apparatus 1. In addition, in one or more embodiments, image optimization apparatus 2 assesses the quality of the output image, and sends a feedback about the assessment result to image forming apparatus 1. Image forming apparatus 1 executes an invalid sheet process on the basis of the assessment result from image optimization apparatus 2. As illustrated in FIG. 1 and FIG. 2, image optimization apparatus 2 includes control section 20, output image reading section 21, quality assessment section 22, and storage section 23.

Control section 20 includes a CPU, a RAM and a ROM as with control section 10 of image forming apparatus 1. Control section 20 performs a centralized control of the operations of the blocks of image optimization apparatus 2.

Output image reading section 21 is, for example, a scanner that optically reads an image output from image forming apparatus 1. Specifically, output image reading section 21 is disposed so as to face both sides of a sheet conveyed thereto. Under control of control section 20, output image reading section 21 optically scans the sheet, forms an image of reflection light of the sheet on a light-receiving surface of a CCD sensor so as to read images on both sides of the sheet and generate read image data. On the basis of the read image data, positional displacement and the color of the output image are detected, and also the quality of the output image is automatically assessed.

Note that output image reading section 21 may include a spectroscopic colorimeter that measures the color value on the basis of the reflectivity or transmittance of light of each wavelength.

Under control of control section 20, quality assessment section 22 assesses the quality of the output image (presence/absence of an abnormal image) on the basis of read image data. Specifically, quality assessment section 22 compares the read image data of the output image and reference data of a correct image. Then, quality assessment section 22 assesses the similarity between the output image and the correct image, and transmits the assessment result to image forming apparatus 1. The assessment result includes whether the image quality of the output image is qualified (OK) or unqualified (NG).

Note that the determination of the image quality of the output image differs depending on the assessment item, the qualifying standard (threshold value) and the like. In addition, when the quality assessment (image analysis) is started at quality assessment section 22, a signal indicating a start of assessment is transmitted to image forming apparatus 1.

For example, storage section 23 is composed of a nonvolatile semiconductor memory, a hard disk drive or the like, and stores reference data used for assessment of the quality of the output image.

For example, the reference data may be read image data of an output image that has been formed by image forming apparatus 1 prior to execution of a printing job. When the output image is recognized as a normal image as a result of a visual quality check, the read image data of the output image is set as reference data and is stored in storage section 23.

In addition, for example, the reference data may be document image data (so-called raster image processor (RIP) data) generated based on the printing job. In this case, document image data is provided from image forming apparatus 1 to image optimization apparatus 2 and is stored in storage section 23.

Post-processing apparatus 3 includes control section 30, sheet detection sensor 31, sheet ejection tray switching section 32, a plurality of sheet ejection trays 33 (main tray 331, sub tray 332, and purge tray 333) and the like.

Control section 30 includes a CPU, a RAM and a ROM as with control section 10 of image forming apparatus 1. Control section 30 performs a centralized control of the operations of the blocks of post-processing apparatus 3 under an instruction of image forming apparatus 1.

Sheet detection sensor 31 is disposed upstream of a branch point to purge tray 333 in the sheet conveyance direction, and is configured to detect sheets conveyed thereto. The detection result obtained by sheet detection sensor 31 is transmitted to image forming apparatus 1. Image forming apparatus 1 determines whether the quality assessment of the output image (image analysis) can be completed until an executable timing of the invalid sheet process, i.e., whether time over or not, on the basis of the detection result of sheet detection sensor 31. The executable timing of the invalid sheet process is timing when the invalid sheet process can be normally completed, and is, in this case, timing when invalid sheets can be ejected to purge tray 333 by switching the conveyance path.

Sheet ejection tray switching section 32 is disposed at branch points (in FIG. 1, two points) of the conveyance path, and switches the conveyance path of a sheet conveyed thereto under control of control section 30. When the output image is a normal image, sheet ejection tray switching section 32 switches the conveyance path, and ejects a normal sheet on which the normal image is formed to main tray 331, for example. In addition, when the output image is an abnormal image, sheet ejection tray switching section 32 switches the conveyance path, and ejects the invalid sheet on which the abnormal image is formed to purge tray 333, for example.

In one or more embodiments, image forming apparatus 1 performs the invalid sheet process on the basis of an assessment result of image optimization apparatus 2.

In the invalid sheet process, image forming apparatus 1 provides an instruction about the sheet ejection tray to post-processing apparatus 3 such that normal sheets are ejected to main tray 331 and invalid sheets are ejected to purge tray 333, for example. With this configuration, only normal sheets are ejected to main tray 331, and thus a high quality output product in which no invalid sheet is mixed can be produced.

Incidentally, in image optimization apparatus 2, time over may occur when the quality assessment of the output image may not be completed within a predetermined time. In such a case, no problem arises when the output image is a normal image; however, when the output image is an abnormal image, an invalid sheet may be ejected to main tray 331 and mixed with normal sheets without being ejected to purge tray 333. In addition, once time over occurs, the image analysis of succeeding output images tends to result in time over, and the invalid sheet process for the case where an abnormal image is detected may not be normally executed.

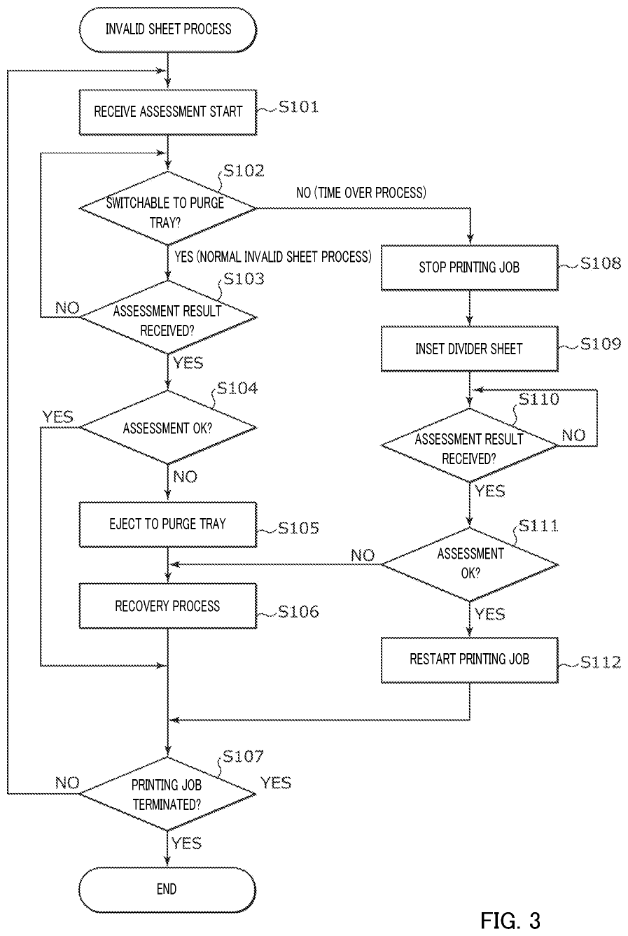

In view of this, in one or more embodiments, a time over process is performed in the invalid sheet process such that a sheet that has resulted in time over (hereinafter referred to as “time-over sheet”) is appropriately processed. Specifically, the invalid sheet process (including the time over process) is performed in accordance with the flowchart illustrated in FIG. 3.

FIG. 3 is a flowchart of an exemplary invalid sheet process executed by CPU 101. This process is achieved when CPU 101 executes invalid sheet processing program 171 stored in storage section 17 in response to a start of a printing job by image forming apparatus 1, for example. In one or more embodiments, CPU 101 of image forming apparatus 1 functions as an invalid sheet processing section, a time-over processing section, and a recovery processing section.

At step S101 in FIG. 3, CPU 101 receives an assessment start signal indicating a start of image analysis of an output image from image optimization apparatus 2.

At step S102, CPU 101 determines whether the path can be switched to purge tray 333, i.e., whether the timing is an executable timing of the invalid sheet process. For example, when a detection signal indicating arrival of a sheet is received from sheet detection sensor 31 of post-processing apparatus 3 before receiving an assessment result from image optimization apparatus 2, it is determined that the invalid sheet process cannot be executed (time over).

When the timing is an executable timing of the invalid sheet process (at step S102 “YES”), the process proceeds to step S103, and a normal invalid sheet process is executed. When the timing is not an executable timing of the invalid sheet process (at step S102 “NO”), the process proceeds to step S108, and the time over process is executed.

At step S103, CPU 101 determines whether an assessment result has been received from image optimization apparatus 2. When an assessment result has been received (at step S103 “YES”), the process proceeds to step S104. When no assessment result has been received (at step S103 “NO”), the process proceeds to step S102.

At step S104, CPU 101 determines whether the assessment result of the output image is qualified (normal image, OK) or not (abnormal image, NG). When the image has been qualified (at step S104 “YES”), the process proceeds to step S107. When the image has been unqualified (at step S104 “NO”), the process proceeds to step S105.

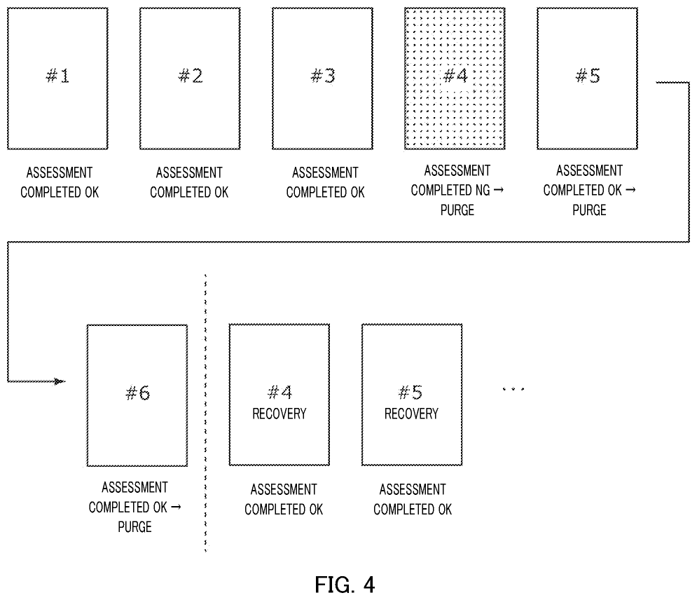

At step S105, CPU 101 instructs post-processing apparatus 3 to eject the invalid sheet on which the abnormal image is formed to purge tray 333. In this case, the printing job is interrupted at the time point when the abnormal image is detected, and succeeding sheets (e.g., two sheets) that have been printed after the invalid sheet are also ejected to purge tray 333 regardless of the image quality (see FIG. 4). In FIG. 4, the page #4 is an invalid sheet, and sheets (normal sheets in FIG. 4) of pages #5 and #6 succeeding the invalid sheet are also ejected to purge tray 333 together with the invalid sheet.

At step S106, CPU 101 performs a recovery process. In the recovery process, the printing is again executed from page #4, where the invalid sheet has been placed (see FIG. 4). To main tray 331, normal sheets of recovered page #4 and succeeding pages are ejected after the normal sheet of page #3. Thus, output products with no incorrect collating or missing leaves can be produced.

At step S107, CPU 101 determines whether the printing job has been completed. When the printing job has been completed (at step S107 “YES”), the invalid sheet process is completed. When the printing job has not been completed (at step S107 “NO”), the process proceeds to step S101.

When time over has occurred at step S102, CPU 101 temporarily stops the printing job at step S108. Sheets that have been printed at this point of time are handled as time-over sheets. While the time-over sheets are ejected to main tray 331, whether they are normal sheets or invalid sheets is unclear at the time point when they are ejected.

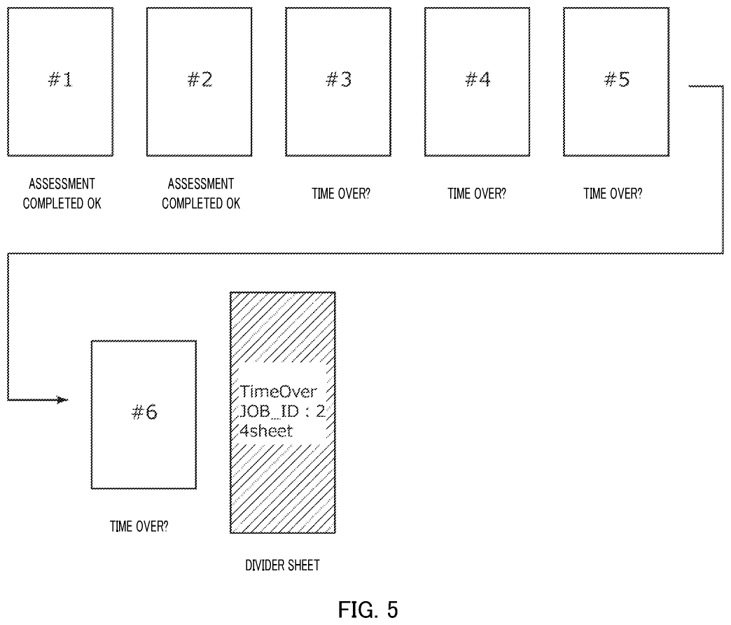

At step S109, CPU 101 controls sheet feeding section 15 to insert a divider sheet (see FIG. 5). In FIG. 5, time over has occurred at page #3, and a divider sheet is inserted after page #6. Pages #3 to #6 are ejected to main tray 331 as time-over sheets.

In one or more embodiments, information relating to time over may be given to the divider sheet. The information relating to time over includes the number of time-over sheets that have been fed in a period from occurrence of time over to insertion of a divider sheet. In FIG. 5, four sheets of pages #3 to #6 are the time-over sheets. In FIG. 5, “2” indicating the job ID of the printing job and “4sheets” indicating the number of the time-over sheets are given to the divider sheet. Such information is printed on the divider sheet by image forming section 19, for example. Note that the information relating to time over may include the serial number of the divider sheet inserted in the output product.

Since time-over sheets can be easily identified based on the information printed on the divider sheet, the time-over sheets can be removed in a proper amount in the case where the time-over sheets include an abnormal image, for example. For example, in the example illustrated in FIG. 5, the four sheets preceding the divider sheet are the time-over sheets, and therefore it is intuitively recognized that the four sheets should be removed when an abnormal image is included in the time-over sheets.

At step S110, CPU 101 determines whether an assessment result of the time-over sheets (in FIG. 5, the four sheets) has been received from image optimization apparatus 2. When an assessment result has been received (at step S110 “YES”), the process proceeds to step S111.

While the process proceeds to the next step S111 after the assessment results of all the time-over sheets have been received in one or more embodiments, step S110 may not be provided in the case where the time required for the process of inserting the divider sheet is estimated to be longer than the assessment time for the time-over sheet.

At step S111, CPU 101 determines whether the assessment result of the output image is qualified (normal image, OK) or not (abnormal image, NG) for each time-over sheet.

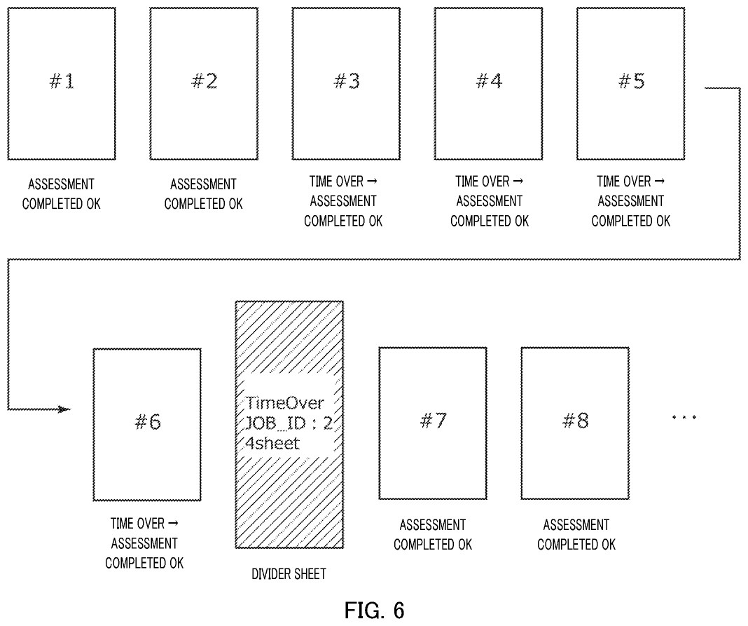

When all the time-over sheets are qualified (at step S111 “YES”), the process proceeds to step S112, and the printing job is restarted (see FIG. 6). In FIG. 6, after insertion of the divider sheet, image formation on page #7 and succeeding pages after the time-over sheets (pages #3 to #6) is performed. In this case, the time-over sheet may be handled as normal sheet, and therefore only the divider sheet is removed after the completion of the printing job.

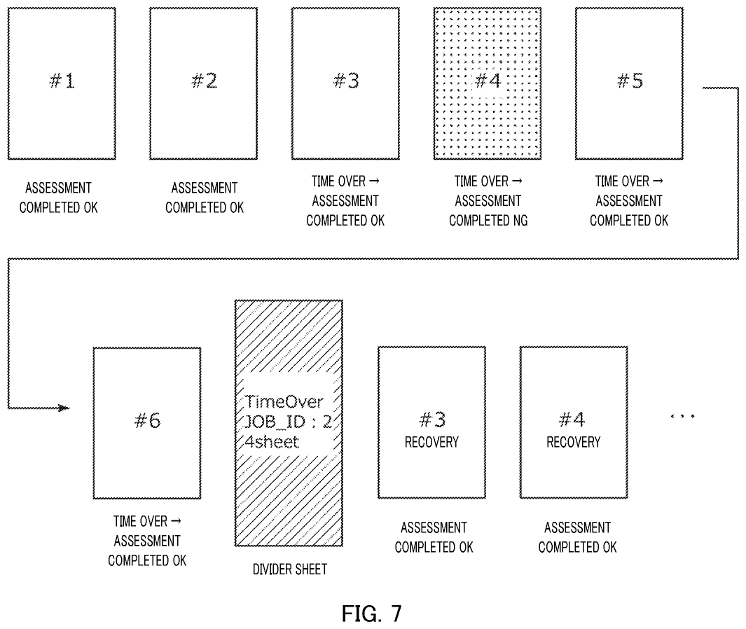

When an abnormal image is included in the time-over sheet (at step S111 “NO”), the process proceeds to step S106, and the recovery process is executed (see FIG. 7). In FIG. 7, after insertion of the divider sheet, recovery of time-over sheets (pages #3 to #6) is performed. In this case, the time-over sheets are handled as invalid sheets, and are removed together with the divider sheet after the completion of the printing job. By collectively handling the time-over sheets together with the normal sheet, incorrect collating or missing leaves in the output products can be prevented.

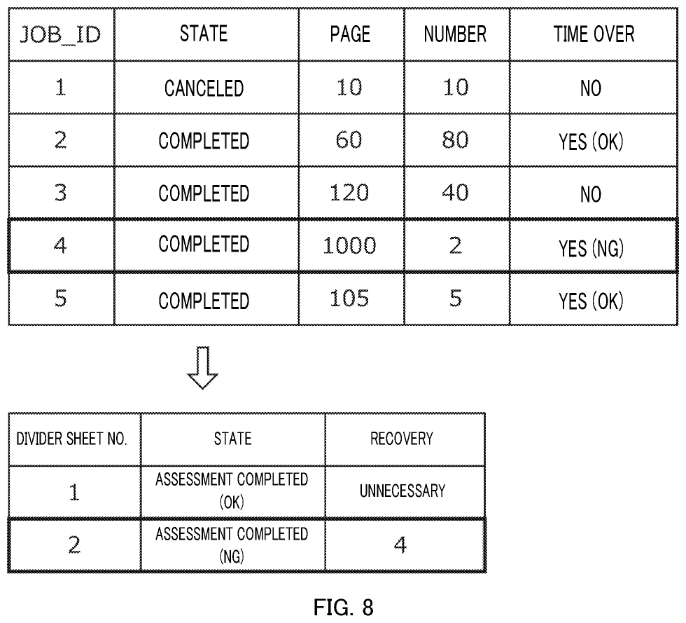

Typically, image forming apparatus 1 is capable of displaying the execution history of the printing job including the execution state of the printing job. In one or more embodiments, as the execution history of the printing job, presence/absence of time over, the assessment result of the time-over sheets and the number of recovered sheets are stored in storage section 17, and are displayed in the form of a job list (see FIG. 8).

FIG. 8 illustrates an exemplary case where, in response to selection of a job from a job list, the information relating to time over of the selected job is displayed. FIG. 8 indicates that the printing job of job ID “4” has been completed, that time over has occurred, that an abnormal image is included in the time-over sheets, and that recovery has been executed for four sheets.

With this configuration, the user can visually recognize the occurrence state of time over and the operation that has been performed for the time over, and thus the convenience in the final confirmation of the output products increases.

As described above, image formation system S according to one or more embodiments includes image forming section 19 configured to form an image on a sheet on the basis of the printing job, output image reading section 21 configured to read an output image formed on the sheet, quality assessment section 22 configured to assess the quality of the output image on the basis of a reading result obtained by output image reading section 21, CPU 101 that functions as an invalid sheet processing section configured to perform an invalid sheet process when an abnormal image is detected by quality assessment section 22, and CPU 101 serving as a time-over processing section configured to interrupt execution of the printing job when time over, in which the quality assessment of the output image cannot be completed by quality assessment section 22 within a predetermined time, has occurred. CPU 101 restarts the execution of the printing job after insertion of the divider sheet indicating occurrence of time over.

In addition, the image assessment method according to one or more embodiments includes a first step of reading an output image formed on the sheet on the basis of the printing job, a second step of assessing the quality of the output image on the basis of the reading result of the first step, a third step of performing an invalid sheet process when an abnormal image is detected by the second step (at step S101 to S105 in FIG. 3), and a fourth step of interrupting execution of the printing job when time over, in which the quality assessment of the output image cannot be completed within a predetermined time by the second step, has occurred (at step S102 “NO”), and restarting execution of the printing job after insertion of the divider sheet indicating occurrence of time over.

In addition, invalid sheet processing program 171 according to one or more embodiments causes a computer of an image formation system configured to form an image on a sheet on a basis of a printing job; to read an output image formed on the sheet; and to assess quality of the output image on a basis of a reading result, i.e., CPU 101, to execute a first processing of performing an invalid sheet process when an abnormal image is detected (at steps S101 to S105 in FIG. 3); and a second processing of interrupting execution of the printing job when time over has occurred, and restarting the printing job after inserting a divider sheet indicating occurrence of the time over, in which the time over occurs when quality assessment of the output image is not completed within a predetermined time in the assessment section 22 (steps S108 to S112).

Invalid sheet processing program 171 is provided with a computer-readable transportable storage medium (an optical disk, an optical magnetic disc, and a memory card) retaining this program, for example. In addition, for example, a program for toner discharge control may be provided through download via a network from a server retaining the program.

With image formation system S, the image assessment method, and the invalid sheet processing program 171 according to one or more embodiments, the user can recognize, from the divider sheet mixed in the output products, the presence of a time-over sheet, i.e., a possibility of failure of the invalid sheet process (failure of reflection of the assessment result to the ejection destination). With such a configuration, the image quality of the time-over sheet can be checked afterward using the divider sheet as a guide. Accordingly, the image quality of the output products can be guaranteed even when time over has occurred.

The printing job is temporarily stopped, but the job is restarted after the time over process, and thus the productivity of the printing job is not significantly impaired.

In addition, in image formation system S, CPU 101 that functions as the time-over processing section gives the divider sheet information relating to time over including the number of sheets that have resulted in time over.

With this configuration, the user can easily identify time-over sheets, and in the case where an invalid sheet is included in time-over sheets, such a sheet can be easily removed.

In addition, in image formation system S, CPU 101 that functions as the time-over processing section restarts the execution of the printing job after acquiring an assessment result of the output image that has formed in the period from occurrence of the time over to the insertion of the divider sheet.

With this configuration, the time over can be reliably canceled, and the time-over sheet can be appropriately handled in accordance with the assessment result. For example, in the case where an invalid sheet is included in time-over sheets, the recovery process can be executed.

In addition, image formation system S includes CPU 101 that function as a recovery processing section configured to perform recovery output of the output image formed in the period from occurrence of the time over to the insertion of the divider sheet when an abnormal image is included in the output image formed in the period from occurrence of the time over to the insertion of the divider sheet.

With this configuration, output products with no incorrect collating and missing leaves can be produced by simply removing the time-over sheet and the divider sheet from output products.

In addition, image formation system S includes storage section 17 (job history storage section) configured to retain the execution history of the printing job, and display section 12 configured to display the execution history. The execution history includes presence/absence of occurrence of time over and the assessment result of the output image that has resulted in the time over.

With this configuration, the user can recognize the occurrence state of time over and the operation performed for the time over on the basis of the execution history of the printing job as visual information, and thus the convenience in final confirmation of the output products increases.

In addition, in image formation system S, CPU 101 that functions as the invalid sheet processing section ejects the invalid sheet on which the abnormal image is formed to purge tray 333 differing from normal sheet ejected main tray 331 when an abnormal image is detected in the invalid sheet process.

With this configuration, basically, the output products in main tray 331 does not include an invalid sheet, and thus, when time over has occurred, final products can be easily obtained by simply removing the divider sheet and, as necessary, the time-over sheet.

While the invention made by the present inventor has been specifically described based on the above-mentioned one or more embodiments, it is not intended to limit the present invention to the above-mentioned one or more embodiments but the present invention may be further modified within the scope and spirit of the invention defined by the appended claims.

For example, while image optimization apparatus 2 includes quality assessment section 22 in one or more embodiments, quality assessment section 22 may be incorporated in image forming apparatus 1 and/or post-processing apparatus 3. In addition, quality assessment section 22 may be composed of an apparatus that is physically independent of image forming apparatus 1, image optimization apparatus 2 and post-processing apparatus 3.

For example, while the recovery process is automatically performed when an abnormal image is included in the time-over sheet in one or more embodiments, the recovery process may be manually executed after completion of the printing job, or in the middle of execution of the printing job. For example, an instruction for executing the recovery process may be provided from a job list as illustrated in FIG. 8. In this case, the output image having been subjected to the recovery process is ejected to sub tray 332 separated from main tray 331, and is replaced with a time-over sheet using the divider sheet as a guide after completion of the printing job.

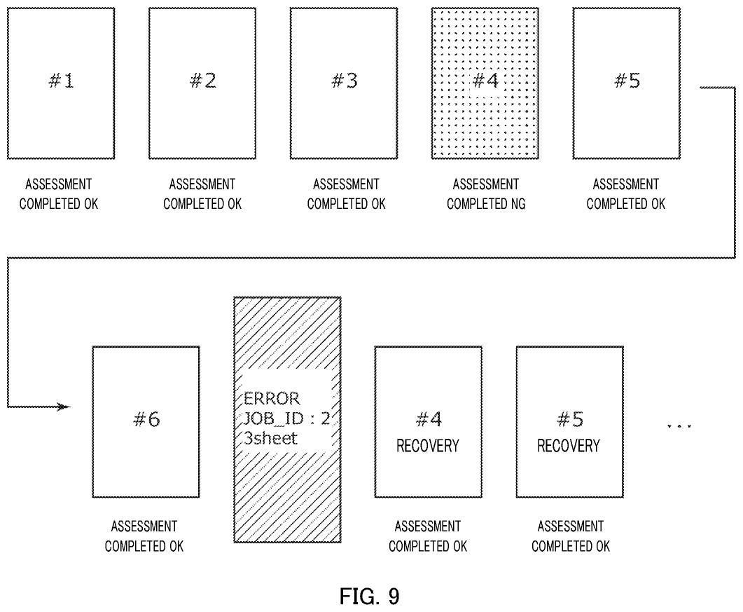

While the invalid sheet is ejected to purge tray 333 in the invalid sheet process in one or more embodiments, the present invention is applicable to a case where a divider sheet indicating generation of an abnormal image is inserted after the invalid sheet in the invalid sheet process (see FIG. 9). FIG. 9 illustrates a case where page #4 is an invalid sheet, and a divider sheet indicating generation of an invalid sheet is inserted after page #6, and thereafter, the recovery process is performed from page #4.

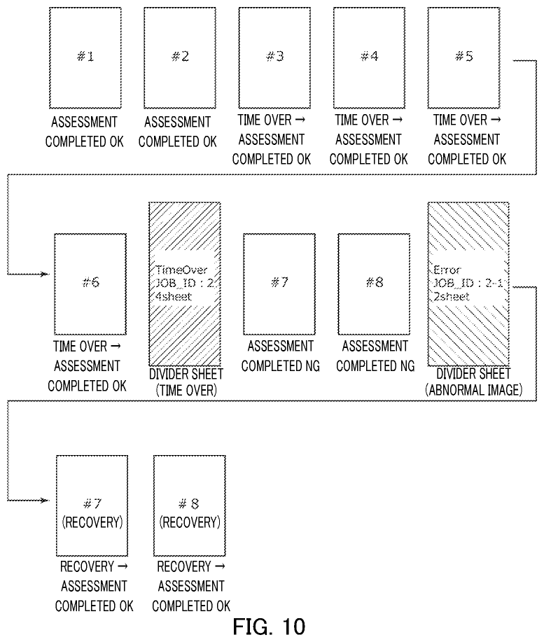

In this case, if a divider sheet indicating occurrence of time over is inserted, a divider sheet indicating occurrence of time over and a divider sheet indicating generation of abnormal image are mixed as illustrated in FIG. 10, and consequently incorrect collating and missing leaves may result.

In view of this, CPU 101 serving as the time-over processing section may insert a divider sheet indicating occurrence of time over only when a divider sheet indicating generation of an abnormal image is not inserted. In this manner, incorrect collating and missing leaves in the output products can be prevented.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image formation system comprising:
a hardware processor that:
forms an image on a sheet based on a printing job;
reads an output image formed on the sheet;
assesses a quality of the output image based on the read output image;
executes an invalid sheet process when an abnormal image is detected;
interrupts, after executing the invalid sheet process, the printing job when a time over has occurred; and
restarts the printing job after inserting a divider sheet that indicates an occurrence of the time-over,
wherein the time-over occurs when quality assessment of the output image is not completed within a predetermined time.

2. The image formation system according to claim 1, wherein the divider sheet includes information that relates to the time-over including a number of sheets that caused the time-over.

3. The image formation system according to claim 1, wherein the hardware processor restarts the printing job after acquiring a result of the quality assessment of the output image that was formed within a period from the occurrence of the time-over to an insertion of the divider sheet.

4. The image formation system according to claim 3, wherein when the abnormal image is included in the output image, the hardware processor further executes a recovery output of the output image.

5. The image formation system according to claim 1, further comprising:
a memory; and
a display that displays an execution history of the printing job,
wherein the processor further stores the execution history in the memory; and
the execution history includes presence/absence of the occurrence of the time-over and a result of the quality assessment of the output image that caused the time-over.

6. The image formation system according to claim 1, wherein when the abnormal image is detected, the hardware processor further, during the invalid sheet process, ejects an invalid sheet on which the abnormal image is formed to a sheet ejection tray that is different from a sheet ejection tray to which a normal sheet is ejected.

7. The image formation system according to claim 1, wherein when the abnormal image is detected, the hardware processor further, during the invalid sheet process, inserts a divider sheet that indicates generation of an invalid sheet.

8. The image formation system according to claim 7, wherein when the divider sheet that indicates the generation of the invalid sheet is not inserted, the hardware processor further inserts the divider sheet that indicates the occurrence of the time-over.

9. An image assessment method comprising:
reading an output image on a sheet, wherein the output image is formed based on a printing job;
assessing a quality of the output image based on the read output image;
executing an invalid sheet process when an abnormal image is detected during the assessing of the quality;
interrupting, after the executing of the invalid sheet process, the printing job when time-over has occurred; and
restarting the printing job after inserting a divider sheet that indicates an occurrence of the time-over,
wherein the time-over occurs when quality assessment of the output image is not completed within a predetermined time.

10. A non-transitory computer-readable recording medium storing a program that causes a computer of an image formation system that forms an image on a sheet based on a printing job, reads an output image formed on the sheet, and assesses a quality of the output image based on the read output image to:
execute an invalid sheet process when an abnormal image is detected;
interrupt, after executing the invalid sheet process, the printing job when time-over has occurred; and
restart the printing job after inserting a divider sheet that indicates an occurrence of the time-over,
wherein the time-over occurs when quality assessment of the output image is not completed within a predetermined time.
